(19) United States
(12) Patent Application Publication
(10) Pub. No.: US 2015/0118667 A1
(43) Pub. Date: Apr. 30, 2015

(54) AUTOMATED LIFELOGGING TO IDENTIFY, MONITOR, AND HELP ACHIEVE USER GOALS

(71) Applicant: ARO, Inc., Seattle, WA (US)

(72) Inventors: Adrienne H. Andrew, Seattle, WA (US); Michael Perkowitz, Seattle, WA (US)

(21) Appl. No.: 14/521,726

(22) Filed: Oct. 23, 2014

Related U.S. Application Data
(60) Provisional application No. 61/895,321, filed on Oct. 24, 2013.

(51) Int. Cl. G09B 19/00

(52) U.S. Cl. CPC G09B 19/00
USPC 434/236

(57) ABSTRACT

A user's activities are automatically logged as they are passively sensed by the user's mobile devices. Patterns of activities or changes in those patterns can be used to identify goals, and users can tell the logging system about other goals directly. The goals may be complex goals having many activities that may contribute to accomplishing the goal. Examples of complex goals include improving health, reducing carbon footprint, and saving money. Progress is monitored toward the user's goal over time. Suggestions are made to the user for how to make progress toward identified goals at times in the user's schedule where a degree of flexibility is available. The suggestions may be based on activities that worked for other people with similar profiles to the user (e.g., in terms of goal, schedule, characteristics, likes/dislikes, stage of change, motivation level, etc.).

### CROSS-REFERENCE TO RELATED APPLICATION

This application claims the benefit of U.S. Provisional Application No. 61/895,321, filed Oct. 24, 2013, which is hereby incorporated by reference in its entirety.

### BACKGROUND

1. Technical Field

The described embodiments generally pertain to interpreting location data and other data about a person collected from mobile devices and internetworked services, and specifically to monitoring such data to track progress against user goals.

2. Description of Related Art

Many mobile devices now have the capability of recording location and other information. Having a complete record of when and where the user goes is useful for a variety of applications, including recommendation systems, lifelogging, and goal tracking. However, there are a number of obstacles to building useful applications on top of the kinds of data streams currently available.

First, these data streams are noisy, imprecise, and sometimes unavailable. Global Positioning System (GPS) technology, for example, can be confused by surrounding buildings or other features and is not available indoors. Cell tower triangulation is imprecise, while also unavailable where there are no cell towers. WiFi triangulation is error-prone and also unavailable in the absence of nearby WiFi networks.

Second, sensor readings such as taking satellite or radio readings can cause a significant drain on the device's battery, so they must be done sparingly. Naturally, this increases the uncertainty in the data, with large gaps from one reading to the next.

Third, people generally think about their lives as a collection of time periods with some semantic meaning attached to each period, with a range of levels of abstraction. Raw location data in the form of latitude/longitude readings has no semantic content, and thus does not naturally mesh with how users perceive the corresponding events.

Beyond the challenges of collecting data, there exist a number of barriers to people accomplishing the goals they set out for themselves. One reason is inertia. People tend to get stuck in existing habits and routines which may be counter to their goals. Sometimes it is difficult to break out of these habits and routines because a person fails to remember to change at the right point in time. This may be a particular problem for goals that are of medium importance to a person: goals that are not of top priority to a person may be attended to less frequently, and therefore, while being attractive goals in the abstract, the person may fail to take actions that make progress toward the goals.

### SUMMARY

Embodiments of the invention include a method, a non-transitory computer readable storage medium and a system for automated lifelogging to identify, monitor, and help achieve user goals. A user's activities are automatically logged as they are passively sensed by the user's mobile devices. Patterns of activities or changes in those patterns can be used to identify goals, and users can tell the logging system about other goals directly. The goals may be complex goals having many activities that may contribute to accomplishing the goal. Examples of complex goals include improving health, reducing carbon footprint, and saving money.

In one embodiment, progress is monitored toward the user's goal over time. Suggestions are made to the user for how to make progress toward identified goals at times in the user's schedule where a degree of flexibility is available. The suggestions may be based on activities that worked for other people with similar profiles to the user (e.g., in terms of goal, schedule, characteristics, likes/dislikes, stage of change, motivation level, etc.).

Embodiments of the computer-readable storage medium store computer-executable instructions for performing the steps described above. Embodiments of the system further comprise a processor for executing the computer-executable instructions.

The features and advantages described in the specification are not all inclusive and, in particular, many additional features and advantages will be apparent to one of ordinary skill in the art in view of the drawings and specification. Moreover, it should be noted that the language used in the specification has been principally selected for readability and instructional purposes, and may not have been selected to delineate or circumscribe the inventive subject matter.

### BRIEF DESCRIPTION OF DRAWINGS

FIG. 1A is a diagram illustrating the relationship of sensor data, slices, and contexts, in accordance with an embodiment of the invention.

FIG. 1B is a diagram illustrating one embodiment of a hierarchical structure representing a user's contextual history at multiple levels of granularity.

FIG. 2 is a block diagram illustrating the system environment for creating and using storylines in accordance with an embodiment of the invention.

FIG. 3 is a flow chart illustrating a storyline creation process in accordance with an embodiment of the invention.

FIG. 4 is a flow chart illustrating a process of slicing in accordance with an embodiment of the invention.

FIG. 5 is a flow chart illustrating a process of labeling in accordance with an embodiment of the invention.

FIG. 6 is a flow chart illustrating a process of aggregating slices into chapter in accordance with an embodiment of the invention.

FIG. 7 is a flow chart illustrating a process of helping achieve user goals, in accordance with an embodiment of the invention.

FIG. 8 is a flow chart illustrating a process of identifying a goal, in accordance with an embodiment of the invention.

FIG. 9 is a flow chart illustrating a process of suggesting opportunities to meet a goal, in accordance with an embodiment of the invention.

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION

Embodiments of the invention enable automated lifelogging to identify, monitor, and help achieve user goals. A user's activities are automatically logged as they are passively sensed by the user's mobile device. Changes in logged user activities or patterns in logged user activities are used to identify new goals. Ultimately, the user's schedule can also be used to determine when to suggest opportunities to meet user's goals. Accordingly, the following sections will first describe how the system performs lifelogging by learning the context of the user from observation data.

Briefly, a context is a (possibly partial) specification of what a user was doing in the dimensions of time, place, and activity. Contexts may only partially specify what a user is doing, omitting one or more of a user's time, place, or activity. Contexts can vary in their specificity, their semantic content, and their likelihood. A storyline is composed of a time-ordered sequence of contexts that partition a given span of time that are arranged into groups at a plurality of hierarchical levels. A storyline is created through a process of data collection, slicing, labeling, and aggregation. The storyline data is then available to offer a historical perspective of the user. With knowledge of the user and the user's routine, the system is then able to identify goals, monitor progress towards goals, and suggest opportunities to meet goals, in accordance with embodiments of the invention.

### System Overview

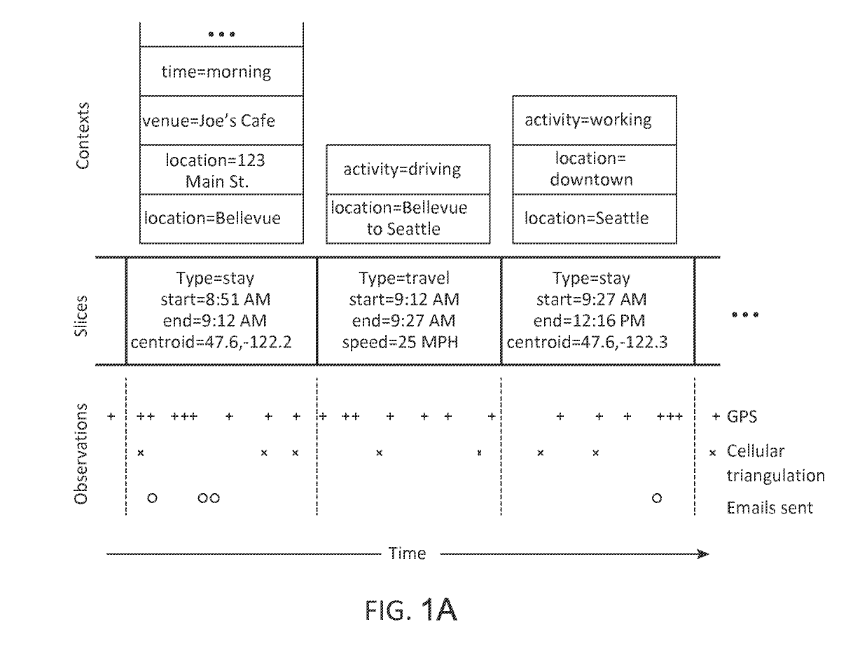

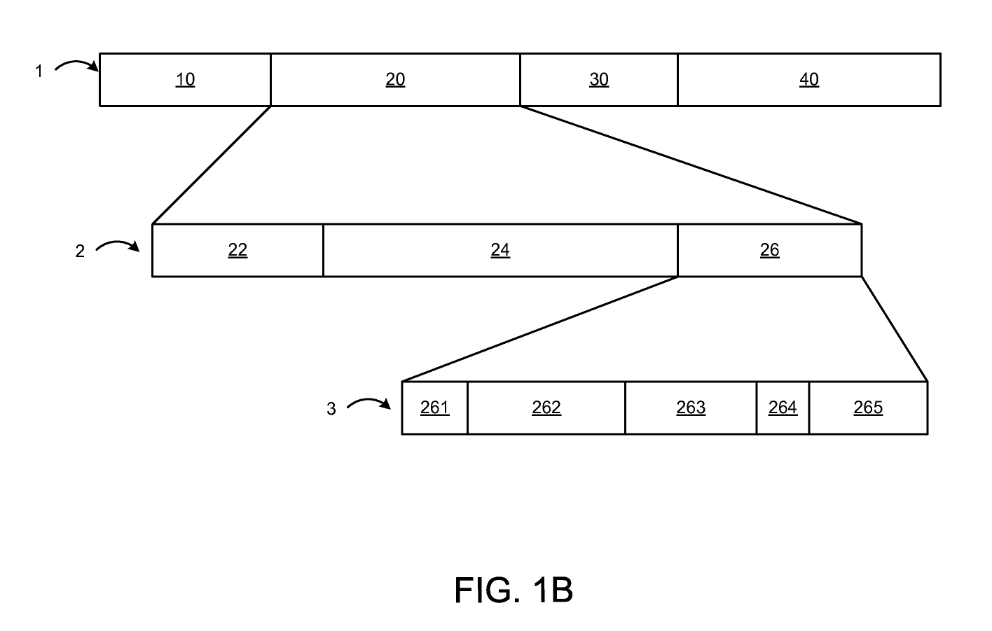

FIG. 1A is a diagram illustrating the relationship of sensor data, slices, and contexts, in accordance with an embodiment of the invention. FIG. 1A illustrates observations, which are the collections of sensor data from a mobile device. In this example, the observations include Global Positioning System readings, cellular triangulation signals, and emails sent from the device. The points along the time axis at which these observations are collected are marked. As a result of these observations, the user's time can be divided into a sequence of slices. In this example, each slice has a type and a start and end time. In this example, the type is either “stay” or “travel” and the start and end times establish the limits or boundaries of the slice. For “stay” type slices, the slice also has a centroid location, and for “travel” type slices, the slice also has a speed of the travel. In this example, based on the division of observations into time slices, a variety of metadata representing contexts have been attached to the slices. The metadata may describe the dimensions of time, place, and activity of the user at various levels of generality. For example, the first slice is associated with a place dimension of the context at various levels of generality/specificity: at a city level, a street address level, and a venue level.

One use of storyline data is to offer a historical perspective to the user, who may peruse the storyline to view his/her previous activities. Another use of storyline data is for further processing into interesting aggregations, e.g., identifying a collection of activities that collectively represent a vacation, identifying a group of slices that represent the user's day at work, identifying a pair of travel slices and a stay slice as a trip to the gym, and the like, in accordance with various embodiments of the invention. Yet another use of storyline data is to inform a summary of the user's personality, e.g. a user having a certain number of chapters identified as “going hiking” may indicate a trait such as “love of the outdoors” and/or “fitness fanatic.” This information can be useful for increasing self-awareness or goal tracking purposes, e.g., seeing how much time was spent exercising or eating out at restaurants per month.

FIG. 1B is a diagram illustrating slices that have been aggregated in a hierarchical structure representing a user's storyline at multiple levels of granularity, according to one embodiment. At the bottom level 3, a chapter 26 is shown as being divided into five slices 261, 262, 263, 264, and 265. For example, the first slice 261 might be a cab ride from the user's hotel to an airport, the second slice 262 might be time spent at the airport, the third slice 263 might be a flight home, the fourth slice 264 might be time spent getting out of the user's home-town airport, and the fifth slice 265 might be a cab ride from the user's home-town airport to the user's apartment. Note that although it is not shown in FIG. 1B, the other chapters will typically also include one or more slices.

At the second level 2, a book 20 is shown as being divided into three chapters 22, 24, and 26. For example, continuing the previous example where the third chapter 26 is a journey home from a hotel, the first chapter 22 might be traveling from home to a ski resort and the second chapter 24 might be ten days of skiing. Note that although it is not shown in FIG. 1B, the other books will typically also include one or more chapters.

At the highest level 1 (representing the complete storyline), the user's storyline is divided into four books 10, 20, 30, and 40. For example, continuing the previous example where the second book 20 is a ski vacation (including travel), the first book 10 might represent a regular work week, the third book 30 might represent three days back at work after the ski vacation, and the fourth book might represent a period of unemployment after the user quit his job to pursue a career as a ski instructor.

Although FIG. 1B shows a storyline that includes books, chapters, and slices, in other embodiments, storylines with different numbers of hierarchical levels are used. In addition, although the illustrated embodiment shows groups that are made up of contiguous slices, in some embodiments non-contiguous groupings are possible. For example, the storyline might include a book identified as “vacations” that includes a first set of slices corresponding to a weekend in Vegas in April and a second set of slices corresponding to a hike in Yosemite in August. As another example, the storyline might include a chapter identified as “Saturday shopping” that includes two sets of slices corresponding to retail stores in a mall separated by a brief visit to the user's office for a Saturday meeting.

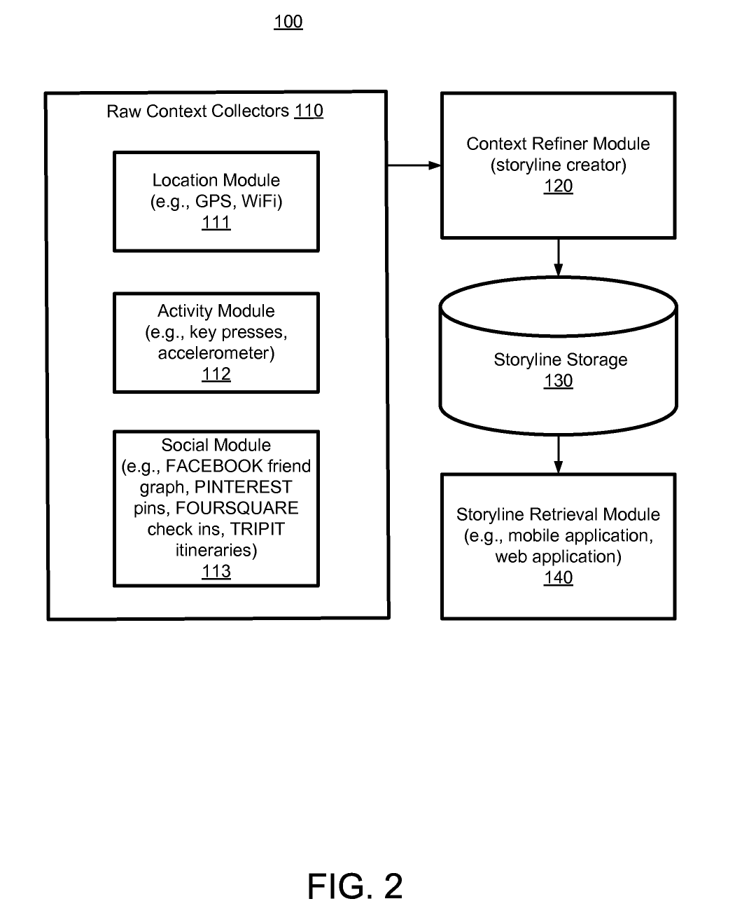

FIG. 2 is a block diagram illustrating a system environment 100 for creating and using storylines, in accordance with an embodiment of the invention. The system environment 100 includes one or more raw context collectors 110, a context refiner module 120, a storyline storage 130, and a storyline retrieval module 140. In one embodiment, the entities of the system environment may be contained on a single processing node, such as a user's mobile device, and in another embodiment, the entities of the system environment may be divided between the user's mobile device and a centralized processing node to decrease the processing requirements of the mobile device. An example distributed embodiment is one where the raw context collectors 111 are located on the user's mobile device and data is sent to a central device of context refinement, storage, and retrieval.

The raw context collectors 110 collect raw context data from observation sources, sensors, monitors, third party sources, and the like. A raw context represents a single observation and so is generally very specific, often carries little semantic information on its own, and is of high probability. Naturally, different observation sources may have greater degrees of noise and uncertainty or may inherently include semantic information. In the example illustrated in FIG. 1, the raw context collectors 110 include a location module 111, an activity module 112, and a social module 113, but different and/or other context collectors 110 may be included in other embodiments. For example, in various embodiments, the context collectors include sensors for measuring device orientation (e.g., a compass), magnetic fields, user heart rate, and user stress level, as well as modules for audio and visual sampling of the user's environment.

Examples of location module 111 include a GPS receiver, and a Wi-Fi receiver that enable the location module 111 to determine an absolute or relative location of the user's mobile device, within a margin of error. Examples of the activity module 112 include, a monitor of key presses and/or screen touches that determines when a user is typing or otherwise interacting with the user's mobile device, and an accelerometer that measures the acceleration forces on the mobile device to determine movement and movement patterns of the mobile device. Examples of social module 113 include a FACEBOOK friend graph, PINTEREST pins, FOURSQUARE check ins, TRIPIT itineraries, and other social media data that identify a user's social acquaintances, activities, and locations. Other context collectors 110 used in some embodiments include health monitors that report metrics such as heart rate and blood pressure, connected instruments such as scales and blood pressure cuffs, and activity monitoring devices such as run trackers and sleep monitors.

The context refiner module 120 receives the raw context data from the raw context collectors 110. The context refiner module 120 groups the context data by combining the observations to create a more coherent representation of the user's context. The context refiner module 120 may also attach semantic content to groups or sequences of context data to form storylines. In some embodiments, the context refiner module 120 includes a plurality of context refiner sub-modules (not shown); one for each type of context data received from the raw context collectors 110. Each context refiner sub-module groups context data by combining the observations from the corresponding raw context collector 110 into slices in order to create a more coherent representation of the user's context indicated by the specific type of context data the sub-module is operating on. In one such embodiment, the context refiner module 120 includes an additional refiner sub-module (not shown) that analyzes the multiple streams of contexts generated by the other context refiner sub-modules to detect overlapping slices and generate combined slices containing context information from the corresponding overlapping slices. The context refiner module 120 aggregates slices to define groups at one or more hierarchical levels (e.g., chapters, books, etc.) that correspond to semantically meaningful concepts such as work days, work weeks, vacations, compound activities (e.g., a shopping trip made up of visits to multiple stores and the corresponding travel), and the like.

The storyline storage 130 receives the storylines formed by the context refiner module 120 and stores them. Then, a storyline retrieval module 140 can access the stored storylines from storage 130. Examples of storyline retrieval modules 140 include mobile applications and web applications that use the storylines stored in storage 130. An example of an application that uses a storyline is a mobile phone application that displays the user's history, showing the user the places the user has stayed and the travel between the stays. Another example of an application that uses a storyline is a social application such as FACEBOOK or PINTEREST that allows the user to share all or part of his storyline with friends. The process of grouping context data and attaching semantic content to form storylines will be described in detail in the section below.

### Storyline Creation Process

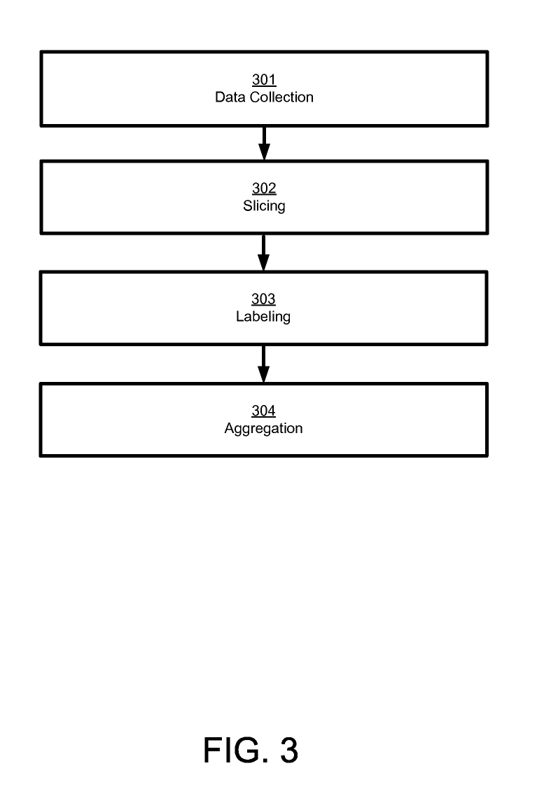

Embodiments of the invention divide the process of storyline creation into four phases: data collection, slicing, labeling, and aggregation. These phases are illustrated in the flow chart of FIG. 3, and described in detail in this section.

Data Collection 301

Data collection 301 involves accessing the various sources of information and observations of user behavior, optionally transporting their data to servers for analysis and storage (to offload CPU load and reduce battery usage), and translating the data into a collection of raw contexts for additional analysis. These observations may come from a variety of sources, including but not limited to the following:
Location technologies (e.g., GPS, cell tower triangulation, Wi-Fi location), typically embedded in mobile devices like smartphones. The location technologies may be included, for example, in the location module 111 illustrated in FIG. 2.
Activity data such as accelerometer data from mobile devices and device interaction notices (e.g. taps, key presses, power on). The activity data may be collected, for example, by the activity module 112 illustrated in FIG. 2.
Ambient data from the user's environment (e.g., sound, temperature, or light intensity).
Biometric data such as the user's skin temperature, galvanic skin response, heat flux, and heart rate. This data may be used to calculate caloric burn, stress level, sleep quality, and other indicators of the user's physical state.
Social data from any networks or applications the user may use, such as FACEBOOK, TWITTER, FOURSQUARE, FLICKR, TRIPIT, or PINTEREST, as well as personal communication applications like email and text messaging. The social data may be collected, for example, by a social module 113 illustrated in FIG. 2. In one embodiment, the social data is made available to the social module 113 through application programming interfaces (APIs).
Schedule data, such as from the user's calendar application.
Explicit annotation created by the user to inform the system of a location (e.g., a “check in” at a baseball stadium) or activity (e.g., marking the time boundaries of a jog to track fitness goals).

Data collection 301 may be run as a constant on-going process, with different techniques appropriate to different sources. Alternatively, data collection 301 may be run periodically at an interval appropriate for the application.

Slicing 302

One challenge with data collection 301 described above is that multiple sources of observation data may result in a collection of contexts that contain conflicting information. For example, an observation from the user's calendar may place him at a meeting downtown, while GPS observations may show him to be at the beach. Resolving these inconsistencies is key to the interpretation of the data. Slicing 302 is the process of refining the chaotic, multi-threaded collection of contexts produced by data collection into a consistent storyline composed of a sequence of contexts representing homogeneous time intervals. These homogeneous time intervals generally represent either a stay at one place or a process of travel from one place to another. In one embodiment, place information may be refined, in that each stay context defines an area that includes most of the individual points observed during that time. Travel contexts will generally have a start and end point, with some definition of the route between them (e.g., waypoints). In one embodiment, travel slices may be further annotated with mode of conveyance (such as driving, walking, flying, or riding a bus), and travel slices may be segmented into distinct slices for different modes of conveyance. For example, a trip involving a drive to the airport, a flight to another city, and a taxi to a hotel might be separated into three distinct travel slices. In another embodiment, no additional semantic meaning or activity information is added during slicing 302. Other types of data can be used to produce other types of slices, such as slices representing a period of consistent activity.

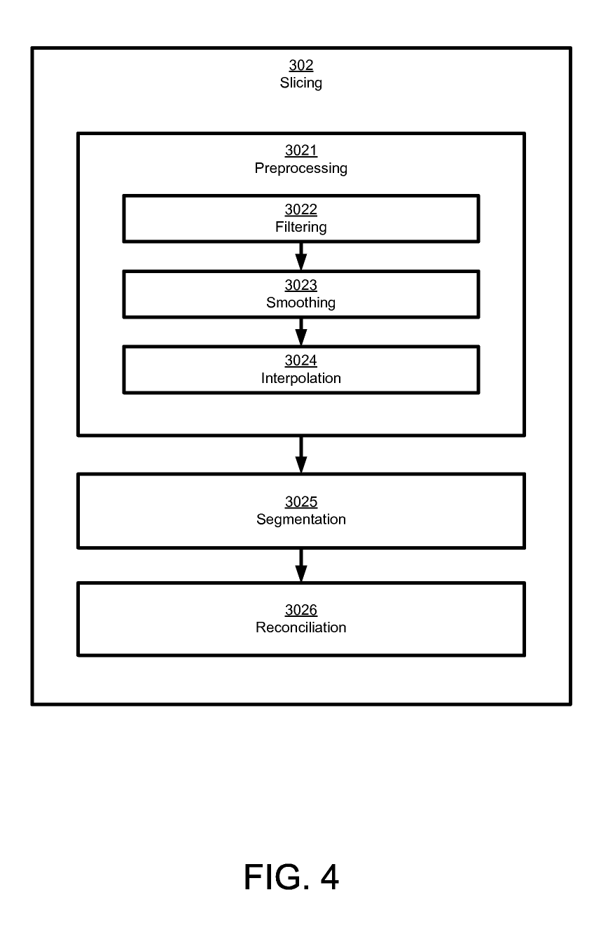

Embodiments of the invention divide the process of slicing 302 into three phases: preprocessing 3021, segmentation 3025, and reconciliation 3026. Each of these phases is described in detail in this section, with reference to the flow chart illustrated in FIG. 4. The steps of FIG. 4 are illustrated from the perspective of the context refiner module 120 performing the method. However, some or all of the steps may be performed by other entities and/or components. In addition, some embodiments may perform the steps in parallel, perform the steps in different orders, or perform different steps.

Preprocessing 3021

Since raw context data input into the slicing 302 process come from a variety of sources with varying degrees of inaccuracy, the raw context data are systematically groomed into a suitable form for later steps to minimize the amount of error in the output. In one embodiment, preprocessing 3021 involves a combination of filtering 3022, smoothing 3023, and interpolation 3024.

Filtering 3022.

Filters on raw context data eliminate from consideration raw context data that are deemed more inaccurate than some desirable threshold. The value of the filter threshold can be sensor-specific, due to different sensor error characteristics. For example, a GPS device's data uncertainty is calculated by physical factors related to the timing of signals received from the device's acquired satellites, so it can report a reliable estimate of sensor inaccuracy. In contrast, reported uncertainty is less reliable with location technology based on cell tower or Wi-Fi triangulation, which lack the measurement precision necessary to account for fluctuations in wireless signal strength, therefore the threshold for filtering 3022 those contexts may be higher. When using any location technology, the amount of filtering 3022 will depend on its expected error characteristics, and the error characteristics are expected to vary between sources of data. Optionally, default threshold values for filters may be set system-wide, set per sensor type, or based on user preferences. In addition to filtering 3022 by location technology, physically unlikely readings (e.g., traveling at higher speeds than possible) may also be filtered.

Smoothing 3023.

It is also helpful to later slicing phases for context grooming to smooth sequences of contexts from the same sensor when each individual context is noisy. Noise characteristics are hardware dependent, so the smoothing 3023 of each sensor should be parameterized to limit the noise expected from that sensor. For example, a certain accelerometer may generate noisy contexts at a high sampling rate, characterized by large magnitude swings in all axes. One way to smooth such data is to compute an average of the magnitude values over a time window and then output the smoothed magnitude values at a less frequent sampling rate. Smoothing 3023 is also used when different sensors conflict. For example, if there is minimal change in values across a series of accelerometer readings, it indicates that a device was immobile, which could contradict a series of location readings that would otherwise suggest the device was wandering due to inaccurate location technology. In general, the degree of smoothing 3023 will depend on the variability in data noise from each particular location technology.

Interpolation 3024.

Uneven sampling rates can also be due to power conservation, where a device chooses to go into a low-power, low sampling rate state, or is forced to by a governing operating system such as a mobile phone OS. It is common for sensors to be configured to increase sampling when the environment is changing, and to decrease it when the environment (from the sensor's perspective) is static. As slicing 302 occurs over a finite window of time, a decreased sampling rate could lead to relevant context data falling outside the window. Therefore, it is desirable in some cases to interpolate less frequent context data to ensure that the later phases of slicing 302 have sufficient data to analyze. Interpolation 3024 generates virtual context data between sensed context data. For example, when there is a gap between two location contexts, a number of interpolated context data points may be generated that correspond to locations between the two endpoints. Interpolation 3024 runs into the risk of adding contexts that should not exist. For example, if a sensor is not functional and therefore not reporting, a gap in contexts should not be interpolated. To prevent invalid interpolation 3024, sensor data payload may include an indication that there has been an interruption in contexts since the last time a sensor generated context. This may be the default behavior whenever a sensor is (re)started for data collection by the controlling data collection process. In addition, if there is an exceptionally long gap between context data from sensors, it may indicate an interruption even if the sensors fail to set the flag and would be treated as such.

Segmentation 3025

Segmentation 3025 involves determining distinct, contiguous series of slices from the groomed sensor data representing different activities. For example, the simple day of a user who is an office worker could be segmented into a stay slice located in the morning at her domicile, then a commute to work travel slice, a stay slice at an office, then a commute back home travel slice, followed by a stay slice in the evening at her domicile.

There are a variety of algorithms to segment the input raw context data into stays, travels, and gaps. For example, k-means clustering can be applied to find clusters of raw contexts (by location, or a distance function combining location and time). Stay slices can be distinguished from travel slices by the dispersion of location context and/or velocity data. Because k-means has fundamental limitations, other more sophisticated clustering algorithms can be used additionally or alternatively to extract slices.

Besides clustering, segmentation 3025 can also be performed by applying time-series analysis algorithms, using the variance of a sliding window of input contexts to detect inflection points in the distribution. When the variation across a subsequence of input context data differs from a subsequence before it, the algorithm divides the two subsequences into slices that can then be classified as a stay or travel. For example, a stay is distinguishable from a travel by the low amount of variance in each individual input context in the stay sequence to its centroid, the geographic average location.

Because there are a variety of algorithms that can be applied to segmentation 3025, each with different features and limitations, it is also possible to combine their resulting outputs with a meta-segmenter. This meta-segmenter can pick and choose slices output with the highest associated probability among all constituent segmentation algorithms.

Segmentation 3025 can also be followed by filter and merge steps that smooth the output slices. Filters can remove short slices with more uncertainty associated with the contexts included therein, e.g., those with few actual sensor observations, and merge adjacent segments that are likely to be the same activity. The thresholds on minimum required observation uncertainty or distance from adjacent segments for filtering and merging can be parameterized to control the false positive rate (groups of raw context data that should not have been segmented) compared to the false negative rate (groups of raw context data that should have been segmented but were not).

Reconciliation 3026

In one embodiment, the final phase of slicing 302 deals with resolving newly generated slices with existing contexts generated from a previous slicing 302 run. While this reconciliation 3026 is optional—if it were computationally feasible to run slicing 302 on an entire raw context set, the brand new contexts could simply replace the older ones—in some cases reconciliation 3026 provides desirable qualities for the purpose of presentation. For example, it is desirable not to change contexts and slices in a user's history that have been previously displayed to the user, unless new data is in significant conflict, because the instability in data shown to the user would appear inconsistent. Instability is even less desirable in cases when the user has performed some operation on a previous context or slice, such as manually labeling or otherwise attaching metadata to it, that the subsequent slicing 302 run would overwrite. As such, there are rules governing when new slices and contexts can replace preexisting data in a user's history.

One way to limit the scope of changes between new and preexisting slices is to specify a time window within which preexisting data may be changed or replaced. Any data outside the window (i.e., older than a certain age), would be left unchanged in later slicing 302 runs. Contexts from newer slices are then integrated into the eligible preexisting slices by comparing type (stay or travel) and time spans. If a new slice is of the same type and begins and ends at approximately the same time as an existing slice, it could retain the same metadata of the existing slice, including any identifier labels (ids) and contexts. When a new slice and old slice overlap in time but conflict in type, the process can prefer the new slice except when there has been manual intervention, for example when a user has already interacted with the existing slice or confirmed it in some way using a user interface. Finally, the last slice is most likely to have changed due to new data, and could have its ending time extended if it aligns with a new slice starting at a time near its own start time, or completely replaced if the type changed (if a previously presumed stay were actually the beginning of a travel slice, for instance).

Labeling 303

Labeling 303 is the process of adding more specific and semantically meaningful data to the slices produced by slicing 302. In one embodiment, some or all of these labels are themselves contexts associated with the slices. In particular, labeling 303 adds geography (such as a slice's city or neighborhood), venue (public places, businesses, or personally significant places like “home”), and activity (such as “working”, “eating”, or “going to see a movie”). Note that the process of labeling 303 may suggest a revision in slicing 302, such as when the labeling 303 process determines that a user was eating and then seeing a movie at the theater next door, while the slicing 302 phase represented both activities as a single slice, prompting the single slice to be split into two successive slices, taking place at distinct venues.

A slice can be labeled using identifiers from predefined data sets, such as public venue records, or automatically generated, for example using a reverse geocoding system that converts latitude and longitude coordinates into an approximate street address. The labeling 303 process uses these data sources to apply probable labels to each slice. Some labels are exclusive while others may coexist alongside one another. Example data sources for the labeling 303 process include:
Public venue database—a set of geographically annotated public venue names, such as businesses, public spaces, or landmarks. The venue data should be able to be queried geographically (e.g., to find likely venues within some specified distance of the slice's observed location observations), therefore it should have a location represented either as a single point (latitude, longitude, altitude) or as a set of points that defines or approximates its shape. The venue may also contain a unique identifier, which is useful, for example, to use to associate the venue with manually entered observations from the user. In addition to location and name, the data entry for the venue may contain other metadata such as address, business hours, categories describing the type of venue, and reviews useful to present back to the user. Because the set of public venues changes over time, this database may be configured to receive updates whenever available.
User-specified database of places—a set of manually or automatically generated locations considered private to the user, identified by location and optionally by name and other metadata the user chooses to attach. The purpose of this database is to provide labels for slices that cannot be associated with public venues due to gaps in coverage. For example, many homes are not public venues and therefore would not be found in any public venue database, so a user may need to manually label his/her home. Labels such as “home” and “work” can also be automatically inferred.
A set of additional labels associated with certain venue metadata such as a venue category. These labels could include descriptions of activities commonly applicable to the venue category (e.g., “jogging” at public parks or “dining out” at restaurants). These labels may be either predefined or automatically extracted, e.g., by analyzing the texts of some corpora such as online reviews. As with venue or place, the user can manually apply an activity label to a slice, or the labeling 303 process can infer it based on a model of likelihood given the input context.
Public and user-specific calendar data—listings of public events and private appointments that can then be applied to matching, consistent slices.
A database to store user corrections to automatically applied labels that were made by the system in error. This database has multiple uses. First, in the case of continuous slicing 302 and labeling 303, the correct label can be used during reconciliation 3026 to prevent incorrect labels from being reapplied. Second, the presence of the correction indicates with high confidence what the correct description for the slice is, and can influence future automated labeling 303 decisions for similar slices. The user corrections may be stored, for example, in storyline storage 130 or similar data store accessible by the context refiner module 120.

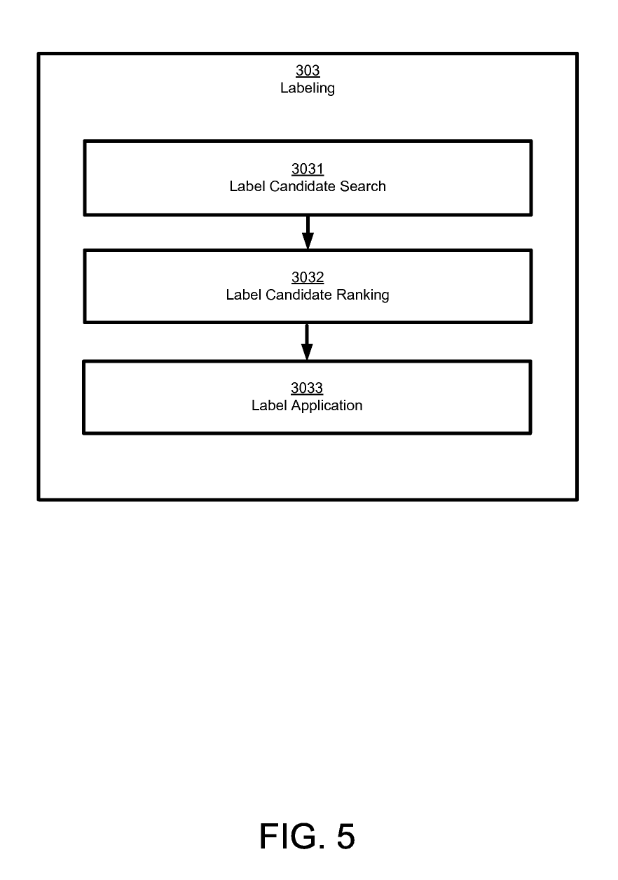

Conceptually, it is possible to view the labeling 303 process as a collection of subprocesses responsible for outputting one type of label at a time. Labels of different types can then be run simultaneously on slices, or chained when one type of label is triggered by the presence of another (i.e., activities that are category- or venue-specific are only considered when a preceding labeling 303 subprocess applies a corresponding category or venue label, respectively, to the slice). In general, the labeling 303 process can be broken into three phases: label candidate search 3031, label candidate ranking 3032, and label application 3033, illustrated in FIG. 5.

Label Candidate Search 3031

In the label candidate search 3031 phase, the label sources are first queried to discover possible labels based on the slice's existing contexts. The following provides examples of how various label types can be searched.

Venues and places are found based on the slice's location, which by definition is a consistent estimate of a user's location over a period of time. However, there is a degree of uncertainty when using the associated slice location. Essentially, raw sensors providing locations are imprecise. The label candidate search 3031 phase does not rely on the exact location represented by the slice, but instead expands the search within some radius calculated as an estimate of the uncertainty. For example, if a slice's location was calculated using Wi-Fi triangulation, the triangulation error is often in the tens to low hundreds of meters, so the search process may query for venues and places centered at the slice location within two hundred meters.

Events and appointments can be found based on the slice's location and time boundaries. An event at a venue would be matched against the overlapping time boundaries between the event and the slice. Appointments are also matched against location and time. Because event and appointment time boundaries are imprecise, and slice time boundaries may be imperfect, the slice's time boundaries do not need to exactly match those of an event or appointment. For example, the label candidate search 3031 determines a slice's time boundaries so that the slice's beginning time and the slice's end time are within a threshold of a corresponding time of an event or an appointment. Similarly, the slice location does not need to be an exact match either. The label candidate search 3031 finds possible events and appointments within the likely uncertainty radius of the slice location, where the likely uncertainty is based on precision of the sensor determining the location.

Several methods may also be used to find candidate activities. For example, based on the category and/or venue labels already applied to the slice, the label candidate search 3031 process can bring up associated activity labels. As another example, the slice context can be compared to similar slices in the past if the user had previously labeled activities manually. For example, if a user previously labeled an activity at the same venue or a venue in the same category as the slice that has not yet been labeled with an activity, that activity would be considered as a candidate for labeling the slice.

Label Candidate Ranking 3032

Once a set of label candidates of a given type are found, the likelihood of each one given the contexts already associated with the slice is evaluated. In one embodiment, the likelihood of each label is computed and the labels are ranked. There may also be a threshold for likelihoods, such that if no label is deemed likely enough, none is applied to the slice at all—this avoids the case of having a label (e.g., an incomplete label) applied inappropriately. In one implementation, slices are constrained to only having one label of some types (e.g., venue labels), and the top-ranked label meeting the minimum likelihood threshold is applied to the slice. For other label types, multiple labels can be valid for a single slice, and all labels meeting the minimum threshold of likeliness are applied.

Likelihoods are calculated by scoring a candidate label given the contexts already associated with a slice. A model is defined to be an algorithm for computing likelihoods given slice context. Models treat the various aspects of a slice context as features. Some example features include:
Slice location—while the label candidate search 3031 also uses location to discover the set of eligible labels to apply, a ranking model can further determine the likelihood of a label given its distance to the slice location, or relative likelihood between several candidates (e.g., a venue that is significantly farther from the slice location would to considered less likely, but two venues that differ only a small amount in distance from the slice location may be considered equally likely given the location context, all else being equal).
The particular user whose slice is being labeled—since users have individual differences, a model may use specific algorithms tailored to each to achieve the best labeling accuracy. One example of how an individual user could affect label candidate ranking 3032 is for the ranking process to use the user's accumulated history of slices and labels, some of which the user may have explicitly confirmed to be accurate. Labels that occurred more often in the user's history may be considered more likely when labeling new contexts.
The beginning and end stay times—since different labels are more likely to occur at different times (e.g., restaurants at meal times, rock concerts in the evenings), and events, appointments and activities last for different lengths of time (e.g., movies between 1.5-3 hours), the likelihood of a particular label can depend on the corresponding day and time range.

Besides the context provided by the slice, models can use other sources of information to inform the likelihood estimate. Some example information sources include:
Venue hours of operation—used to reduce the likelihood that a venue be applied to a slice when it's known to be closed during some significant portion of the slice's time boundaries.
Venue popularity—e.g., relative popularity over all time compared to other venues, or historic popularity at the time of day, day of week, etc, which can indicate the likelihood that the label is applicable given the slice's time boundaries. If the duration of the slice is known, it can also be compared to the distribution of stay durations at the venue to determine whether the length of time spent in one place is consistent with other visits to the candidate venue.
Category popularity—used when data is scarce about specific venues in the candidate list. This can also be relative to time of day, day of week, etc., and can also include typical stay durations so that the slice's time boundaries factor into the likelihood calculation.
Routine—considering how often in the past the user has similar slices with the candidate label, can determine whether a certain label is more likely (if there are many such instances) or less likely (if there are few or no instances). Routine is not limited to only considering a specific user's historical patterns. Users might be clustered into cohort groups, or even aggregated into a global routine model, depending on data scarcity due to limited interactions with the system or the area where the slice occurs.
Social interest—some users are more likely to visit a venue if their friends recommended it, if they have been there before, or were labeled as being there during an overlapping time period by the labeling 303 process. Some of this information is available through existing social network APIs, for example recommendations may be based off of a friend “liking” the venue on FACEBOOK. Information about a user's friends visits to a venue can also come from a friend “checking in” or retrieved from the contextual history storage 130 (in embodiments where the storyline storage is centralized).

Label Application 3033

One or more models can be run to process a slice's context(s) into labels, which are applied in label application 3033. Conceptually, multiple models can be represented by a single meta-model that runs the appropriate features through its composing models. Once the meta-model outputs probabilities, labels deemed sufficiently likely are applied to the slice. In one embodiment, labels that are not deemed to be sufficiently likely can still be surfaced as options to the user should he/she wish to alter the label set by adding new labels, with the label candidate ranking 3032 intact. In such cases, it is not necessary for the same meta-model to produce the label candidate ranking 3032—different meta-models can rank labels differently to produce whatever is specified by the system design of a particular embodiment.

In one embodiment, automatic label application 3033 does not require that every label is ranked solely by likelihood. For example, when users interact with the label candidates (e.g., to manually apply labels), it can be desirable to present candidate labels in different orders to make finding desired labels easier. For example, an alphabetical order or a hybrid order that incorporates both likelihoods and lexicographical positions can be used. Once labels are applied to slices, the additional contextual data is presentable to the user and available for further processing in a variety of forms.

Aggregation 304

The collection of labeled slices in a user's storyline provides a great deal of fine detail about the user's day to day movements and activities. However, people generally think about their lives as a collection of time periods with some semantic meaning attached to each period, with a range of levels of abstraction. For example, a work day might include a morning commute, a morning at work, walking to a restaurant, eating lunch, walking back to the office, an afternoon at work, and an evening commute, each represented by a labeled slice. However, in many instances, it will be of greater value to the user to be presented with the entire sequence as a single event (e.g., “work”) rather than the each individual slice. Aggregation 304 is the process of identifying groups of slices that correspond to at least one semantic concept and storing these groups as part of the user's storyline. Unlike during the slicing 302 process, where raw contextual data is merged to create slices, aggregation identifies higher level events (groups) that include one or more slices; both the group and the individual slices are included in the storyline. In one embodiment, users are presented with their hierarchical storylines in an interface that enables them to drill-down and drill-up through the various levels of the hierarchy. For example, a graphical user interface presents the storyline with various interface objects (e.g., shapes, text, images, other media content, or a combination thereof) that represent slices and groups of slices. Responsive to a user command (e.g., a stretch gesture, selection of an interface object) directed at an interface object representing a group of slices, the user interface displays interface objects representing the slices in the group. Responsive to an additional user command (e.g., a pinch gesture, selection of a button) when the user interface displays interface objects representing slices, the user interface displays an interface object representing a group of the slices.

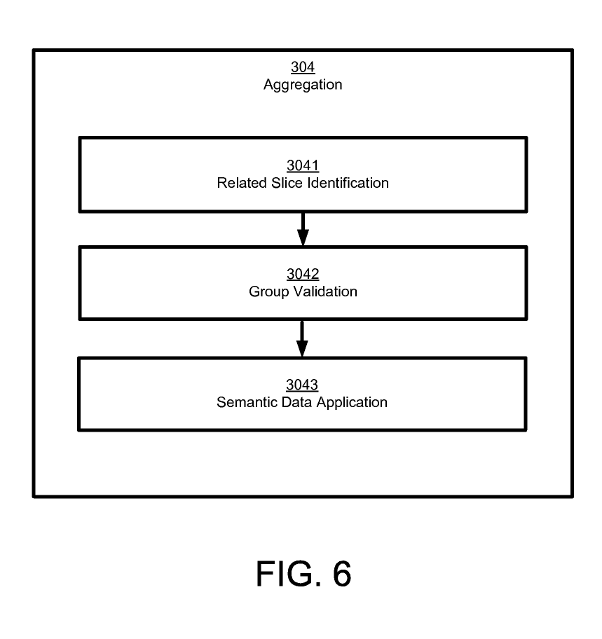

Embodiments of the invention divide the process of aggregation 304 into three phases: related slice identification 3041, group validation 3042, and semantic data application 3043. Each of these phases is described in detail in this section, with reference to the flow chart illustrated in FIG. 6. The steps of FIG. 6 are illustrated from the perspective of the context refiner module 120 performing the method. However, some or all of the steps may be performed by other entities and/or components. In addition, some embodiments may perform the steps in parallel, perform the steps in different orders, or perform different steps.

Related Slice Identification 3041

During related slice identification 3041, the context refiner module 120 uses data from one or more sources to identify groups of slices that may collectively describe a single semantic concept. In one embodiment, data from a user's calendar and/or social applications are used to identify slices that correspond to a particular event. For example, if the user has created an itinerary on TRIPIT (another application storing an itinerary through various geographic locations), all of the slices that fall within the time-range covered by the itinerary can be identified as related. As another example, a range of slices that is bounded by a travel from and to the user's home (e.g., a work day) can be identified as related. As yet another example, all slices falling within a time-range defined by an event on the user's calendar can be identified as related. In one embodiment, a chapter type can be specified that identifies a pattern of slices. The context refiner module 120 recognizes any sequence of slices that matches the pattern as an instance of the chapter type. The pattern could be a sequence of specific venues, venue categories, venue attributes, and/or any combination of these. For example, “Work, travel, <category restaurant>, travel, Work” generically describes “going out for lunch” sequences involving any restaurant visited during the workday. Thus, the context refiner module 120 can automatically identify and aggregate sequences of slices that match the pattern in a way that may be more semantically meaningful than the individual slices in the sequences. Such patterns can be created in various ways, including manually authored by the system designers, manually authored by users, and/or automatically generated from sequence data via machine learning algorithms. In other embodiments, different and/or additional data sources are used by the context refiner module 120 to identify related slices.

Group Validation 3042

Once groups of related slices have been identified, the context refiner module 120 determines which of those groups are likely to correspond to a semantic concept during group validation 3042. In many instances, the information associated with one or more of the identified groups will contradict other identified groups and/or slices. For example, if a group is identified based on a TRIPIT itinerary for a trip to Mexico that the user did not take, the resulting group, which is expected to contain slices located in Mexico, will in fact contain slices indicating the user was at home. The context refiner module 120 considers one or more factors in determining which of the identified groups are likely to correspond to an actual event (or other semantic concept). In one embodiment, the context refiner module 120 ranks the possible sources of location data and, when conflicting location data is identified, uses the data from the most highly ranked source. For example, the context refiner module 120 might consider GPS data from the user's mobile device to be the most reliable (as this is difficult to fake), followed by events on the user's calendar, with data obtained from social applications being considered the least reliable. Thus, in the example given above regarding a planned trip to Mexico, the GPS data indicating the user was at home outranks the itinerary data received from TRIPIT, and the context refiner module 120 may infer that the user did not take the planned trip and/or may ask the user to confirm any inferences. In other embodiments, different and/or additional sources of location data are used, and the sources are ranked in different orders.

In one embodiment, in which only a single hierarchical level of grouping (chapters) is used, chapters are not allowed to overlap with each other. Thus, if two identified groups of slices overlap, the context refiner module 120 determines which one is more likely to represent an event or other meaningful semantic concept. Various methods can be used to determine which grouping to keep, such as favoring longer groupings over shorter groupings, favoring groupings with greater certainty of accuracy for the slices therein, favoring groupings based on higher ranked sources (e.g., as described above with reference to a planned trip to Mexico), favoring groupings that the user has explicitly indicated (e.g., those based on a calendar event the user created) over those based on implicit data, and the like. In other embodiments, a plurality of hierarchical levels are used and the context refiner module 120 attempts to resolve conflicts between overlapping groupings by analyzing whether one is a lower level event that is bounded by another. In one such embodiment, the bounds of groups are in part determined by requiring that a group at a higher level begins and ends at times corresponding to the beginning and end of groupings (and/or individual slices) in the level below. For example, the skiing vacation book group described earlier must begin at the same time as the cab ride to the airport and end at the same time that the user arrives back home. In yet another embodiment, multiple storylines may cover the same or overlapping sets of slices without necessarily being related at all. For example, if Alice travels to France and meets Bob there halfway through her visit, and then both travel to Germany together, Alice's storyline may contain the semantic groupings “France visit” and “travel with Bob.” These groupings overlap, but neither fully contains the other. Disjoint storylines are another example of overlap; Alice may have storylines for “places I ate” and “famous landmarks”, both of which include a famous restaurant.

Semantic Data Application 3043

At the conclusion of group validation 3042, the context refiner module 120 has determined the structure of a hierarchical storyline, with individual slices at the lowest level and one or more levels of grouped slices corresponding to events or other semantically meaningful groupings. The next stage of aggregation 304 is to add semantic data to each group using a process referred to herein as semantic data application 3043. This process is similar to labeling, but applied to groups rather than individual slices, The goal of the process is to provide a short description for each group that explains to the user why the grouping was made. For example, if a chapter corresponds to a collection slices in Yosemite National Park in August 2013, the context refiner module 120 might add the description “Yosemite, August 2013.” If that chapter is in turn part of a book that includes trips to multiple national parks throughout July and August, the context refiner module 120 might describe the book as “National Park Tour: Summer 2013.” In various embodiments, the information used to identify groupings comes from various sources, including public venue databases, user specified databases, the user's calendar (descriptions of events), the user's social applications (e.g., venues the user checked in at on FOURSQUARE), information obtained by prompting the user to describe an unidentified grouping, and the like. In embodiments where pattern rules are used to detect certain kinds of chapters, patterns may be similarly used to determine semantic labels, such as “<city> Trip, <year>”.

Once the hierarchical storyline structure has been built and the various groupings provided with descriptive information, the storyline is presentable to the user and available for further processing in a variety of forms. As described above, one use of the storyline is to offer a historical perspective to the user, who may peruse the storyline to view his/her previous activities, drilling up and down through the levels of the hierarchy. The storyline data is also available for further processing into additional interesting aggregations, e.g., showing how often certain activities were performed within some time period, or for processing by other software applications.

### Goal Tracking Process

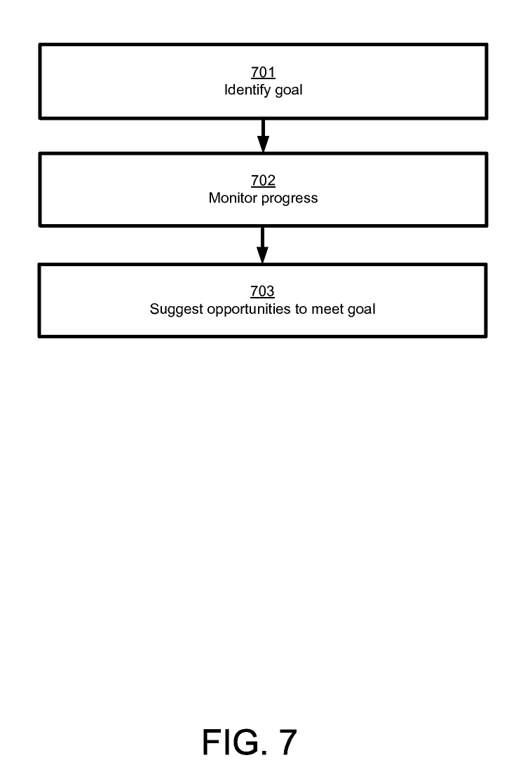

Embodiments of the invention divide the process of helping users achieve goals into three phases: identifying a goal 701, monitoring progress 702, and suggesting opportunities to meet the goal 703. These phases are illustrated in the flow chart of FIG. 7, and described in detail in this section.

Identify Goal 701

A goal is a pattern of behavior that a person wants to adopt. Examples include going to the gym a certain number of times per week, eating at more highly-rated restaurants, eating out less frequently and cooking more, spending more time outdoors, taking a few moments to stretch every hour while at work, reducing stress and anxiety, and many others. Goals are typically ongoing: the user would like to continue some activity at a particular (or minimum) frequency indefinitely, or for some period of time. The target frequency (e.g., “three times per week,” “less than 25% of the time,” “daily,” “four times by the end of the year”) provides a measurable score. Goals can also be one-time tasks. For example, tasks that need to be accomplished, where the exact location and timing may not be specified (e.g., “I need to drop by the post office sometime this week.”). In these cases, the target frequency can be considered to be “at least once.” In either case, the activity is something that the system can sense directly (or infer from available information). In some cases, the user defined goal, such as “exercise three times per week” may be translated into a set of venues, venue types, and activities (going to a gym, taking a walk, doing yoga) which can be observed. In some cases, goals represent a user's aspirations to make a variety of changes to the user's behavior, all of which contribute to the goal. Goals for which a variety of different behaviors all contribute to accomplishing the goal are referred to herein as “complex goals.” For example, a user with a complex goal of “improving health” may desire to get more exercise, cook at home more, reduce stress, spend more time outside, and many others. As another example, a user with a complex goal of “going green” may desire to take public transportation, shop at locally-sourced grocery stores, spend more time outdoors.

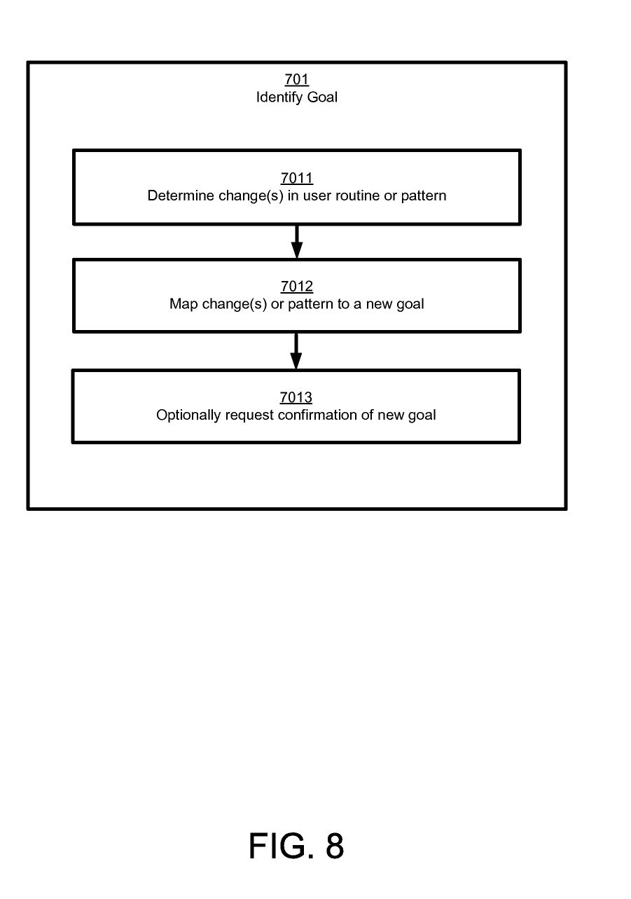

Identifying a goal 701 involves the system discerning user goals based on user input (e.g., the user inputs or selects from among options “I want to take public transportation more often,” “I want to try a new restaurant every week,” or any other goal that is capable of being passively monitored based on information that can be collected from the raw context collectors 110 discussed above). Alternatively, the system may infer user goals based on patterns of behavior or changes in behavior passively observed, and may request confirmation from the user regarding if observed behavior is the subject of a new goal. FIG. 8 is a flow chart illustrating an example process of identifying a goal, in accordance with an embodiment of the invention.

In step 7011, changes in a user routine are determined, or alternatively, a pattern in a user routine is determined. For example, if a user who habitually visits a poor quality fast food restaurant at lunch during the week instead dines at a highly rated restaurant, this may be indicative of a new goal. As another example, if it is observed that a user begins going to the gym a few times in a week, this may be indicative of a new goal related to improving health. If the user already has a habit of going to the gym three times per week, this may suggest a goal of continuing the healthy habit. In one alternative embodiment, the system recognizes a user habit, such as frequent gym visits, but does not communicate with the user about it until the user's behavior changes (e.g., the user stops going to the gym), and then the system asks if the use intends to return to the habit/goal. Because either changes in routine or patterns in routine may signal a goal, the following steps of the method illustrated in FIG. 8 help establish reasonable limits as to what might be indicative of a goal.

In step 7012, the changes or pattern are mapped to a new goal. In one embodiment, only certain classes of changes or certain classes of patterns will map to a new goal. In one implementation, the system stores information about common goals and checks to see if any existing behavior matches any one of the goals. If so, then the system posits that it is a goal that the user wants to achieve. This helps avoid the danger that any behavior or pattern could be interpreted as a goal. The system is biased toward certain kinds of common goals, such as those related to health, wellness, and enhanced enjoyment of life. This allows an inference that frequent gym visits indicate an exercise goal while frequent drug store visits do not signify a going-to-drugstores goal. These biases are provided to the system a priori and may be the result of surveys, sociological research, crowd sourcing, or other methods. Other behavior of the user may also indicate goals. For example, a person who expands his lifelogging system with a scale that can report whenever the user weighs himself is assumed to have a goal around weight, as well as possible related goals around health and diet.

In step 7013, optionally, the system may request confirmation of a new goal from the user. For example, the system may prompt the user by displaying a message that a pattern or change in routine has been noticed, and asking for verification of whether the change corresponds to a goal of the user. The system may suggest other related goals as well (e.g., “I see that you generally visit the gym three times per week. Is this an ongoing goal? Should I monitor other forms of exercise as well?”). Goals that are confirmed by the user are then monitored to assess progress toward the goal, and goals that are rejected by the user are not.

As the system learns the goals of the user, the presence of one goal may make the system more likely to infer related goals from other behavior. For example, a person who jogs regularly and then takes a bike ride may be presumed to be more likely to have a “cycling exercise” goal than someone who does not regularly exercise.

Monitor Progress 702

Monitoring progress 702 involves assessing the user's behavior against the target frequency. For complex goals, a composite score may be calculated and reported. The system can report progress against goals in a variety of ways. For example, the system may report a current score against the target frequency (e.g., “you've met your exercise goal of at least three times this week.”) The system may report a raw score (e.g. “you've exercised four times this week.”) The system may report a score over time, with interpretation of trends (e.g., “you have been exercising an increasing amount lately: you exercised four times this week, three times last week, and two times the week before.”) The system may report a comparison of the user to the same user in another context (e.g., “you are exercising more than you did before you began this goal.”) The system may report a comparison of the user to other cohorts of people such as friends, users that have adopted the same goal, users in the same geographic area, users with the same demographics, users with similar behavior, etc. (e.g., “you exercise 0.4 times more often per week than others of your age and gender” or “you exercise 1.2 times more often per week than others who work in Seattle.”)

Suggest Opportunities to Meet Goal 703

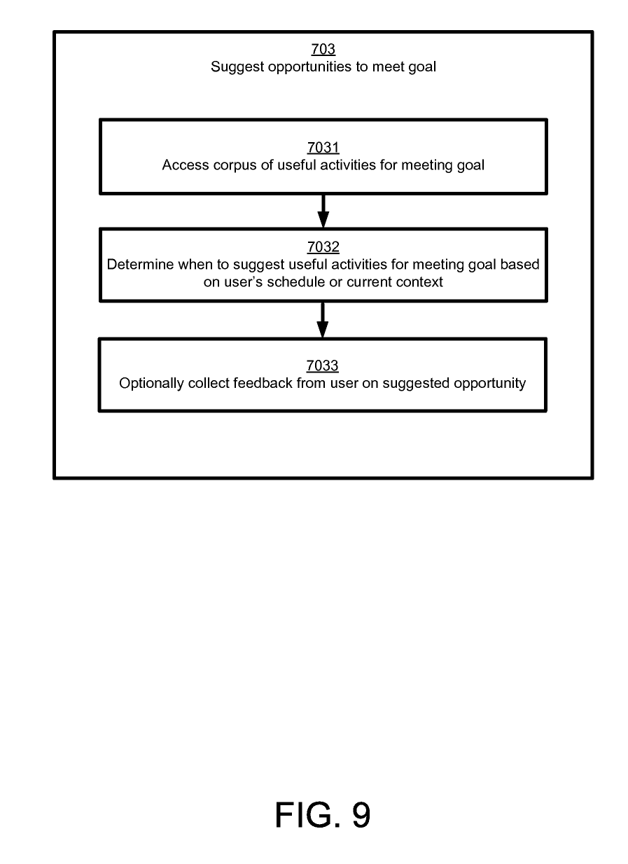

Suggesting opportunities to meet a goal 703 involves prompting the user at appropriate times to adopt behavior that advances the user's goal. FIG. 9 is a flow chart illustrating a process of suggesting opportunities to meet a goal, in accordance with an embodiment of the invention.

In step 7031 a corpus of useful activities for meeting a goal is accessed. The corpus may be populated from surveys, behavioral analysis of others having similar goals, or other means of compiling a set of activities that support accomplishing a user defined goal within the system. Through ongoing data collection, the system collects examples of activities the user could do to meet the goal and collect data as to the usefulness of the activities. For example, if the system can evaluate the activities that a user does to assess whether they constitute exercise (e.g., visits to the gym, visits to the playfield, sustained movement according to accelerometer, walking, cycling, etc.) then the system can suggest these activities to meet other users' exercise goals. Over time, the system will develop metrics that characterize how users make use of the useful activities and patterns of behavior that result in success in accomplishing a goal. This information can be shared with the user in order to influence behavior. For example, perhaps it is determined through analysis of collected data that users who have a goal of “cooking at home more” are 80% more successful if they visit a farmer's market on the weekend than those who do not visit a farmer's market on the weekend. This type of information may be conveyed to the user at the same time as making suggestions.

In step 7032 based on the user's future schedule or current context, it is determined when to suggest useful activities for meeting the goal. Suggestions may be preferentially made during “malleable” times in a user's schedule. Malleable times are times that are not fixed or constrained by the user's prior scheduled commitments, but rather the user has a degree of flexibility with regard to how the user will spend the time. During malleable times, the user tends to undertake a variety of activities rather than rigidly following a routine. For example, the system may observe that the user almost always drives straight to work in the morning, but often stops at the grocery, drug store, cleaners, or a book store on the way home in the evening. In this case, after work is a more malleable time for the user than the morning. Suggestions can be made for places that are convenient to the user's predicted or actual location for those malleable times. Malleability can also be determined over time by the user's willingness to accept suggestions. For example, the user who almost always drives straight to work but varies her after-work activities may often take suggestions for evening activities but reject those made for the morning. This strengthens the determination of the after-work timeframe being a malleable time and the before-work timeframe as being non-malleable.

Suggestions can also be made to alert a user to a fortuitous opportunity to meet a goal because the user happens to be close to a location or venue where the goal could be met, even if it is not during an identified malleable time. In such instances, the user may choose to adjust the user's schedule to make time for the suggested activity. In these ways the system is opportunistic in making suggestions that are responsive to the user's situation. Accordingly, the user is more likely to be available to follow through with the suggested activities that contribute to the user's defined goals.

In step 7033, optionally, feedback is collected from the user on the suggested opportunities. If the user indicates a desire to see more suggestions in similar categories as the suggested opportunities, this can be considered in determining when to suggest useful activities for meeting the goal in the future. If the user indicates that certain suggestions or categories of suggestions are not useful, this can be considered in step 7032 as well, and the system may adapt the frequency or timing of providing suggestions accordingly. As described above, the feedback from the user can be used to determine whether certain timeframes are malleable in the user's routine. If the user is not receptive to suggestions during certain timeframes, the system may determine these times are non-malleable and plan to make fewer suggestions during the non-malleable times. Conversely, if the user is receptive to suggestions during other timeframes, the system may determine these other times are malleable and plan to make more suggestions during the malleable times in the future.

### Additional Configuration Considerations

A computer is adapted to execute computer program modules for providing the functionality described herein. As used herein, the term “module” refers to computer program logic utilized to provide the specified functionality. Thus, a module can be implemented in hardware, firmware, and/or software. In one embodiment, program modules are stored on a storage device, loaded into memory, and executed by a processor.

Embodiments of the physical components described herein can include other and/or different modules than the ones described here. In addition, the functionality attributed to the modules can be performed by other or different modules in other embodiments. Moreover, this description occasionally omits the term “module” for purposes of clarity and convenience.

Some portions of the above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of computer-readable storage medium suitable for storing electronic instructions, and each coupled to a computer system bus. Furthermore, the computers referred to in the specification may include a single processor or may be architectures employing multiple processor designs for increased computing capability.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus disclosed herein without departing from the spirit and scope of the invention.

What is claimed is:

1. A computer-implemented method for suggesting opportunities to meet user goals, the method comprising:
identifying a user goal, the goal comprising a pattern of behavior that the user wants to adopt, the pattern of behavior comprising an activity to continue at a target frequency for at least a period of time, the activity comprising an activity observable by context collectors of a mobile device or inferable from information gathered by context collectors of the mobile device;
monitoring progress towards the goal by assessing the user's behavior against the target frequency; and
suggesting opportunities to meet the goal by prompting the user to adopt behavior that advances the goal.

2. The method of claim 1, wherein identifying the user goal comprises:
determining a change in the user's routine related to health, wellness, or enhanced enjoyment of life;
mapping the change in the user's routine to a new goal related to health, wellness, or enhanced enjoyment of life; and
requesting from the user confirmation of the new goal.

3. The method of claim 2, wherein identifying the user goal further comprises:
suggesting to the user another related goal to the new goal; and
requesting from the user confirmation of the other related goal.

4. The method of claim 1, wherein monitoring progress towards the goal comprises at least one selected from a group consisting of reporting a current score against a target frequency, reporting trends over time, reporting a comparison of the user to the same user in another context, and reporting a comparison of the user to other cohorts of people.

5. The method of claim 1, wherein suggesting opportunities to meet the goal comprises:
accessing a corpus of useful activities for meeting the goal; and
determining when to suggest useful activities for meeting the goal based on a user's schedule.

6. The method of claim 1, wherein suggesting opportunities to meet the goal comprises:
accessing a corpus of useful activities for meeting the goal; and
determining when to suggest useful activities for meeting the goal based on a user's current context.

7. The method of claim 6, further comprising collecting feedback from the user on the suggested opportunity.

8. A non-transitory computer-readable medium comprising instructions executable by a processor, the instructions for:
identifying a user goal, the goal comprising a pattern of behavior that the user wants to adopt, the pattern of behavior comprising an activity to continue at a target frequency for at least a period of time, the activity comprising an activity observable by context collectors of a mobile device or inferable from information gathered by context collectors of the mobile device;
monitoring progress towards the goal by assessing the user's behavior against the target frequency; and
suggesting opportunities to meet the goal by prompting the user to adopt behavior that advances the goal.

9. The medium of claim 8, wherein the instructions for identifying the user goal comprise instructions for:
determining a change in the user's routine related to health, wellness, or enhanced enjoyment of life;
mapping the change in the user's routine to a new goal related to health, wellness, or enhanced enjoyment of life; and
requesting from the user confirmation of the new goal.

10. The medium of claim 9, wherein the instructions for identifying the user goal further comprise instructions for:
suggesting to the user another related goal to the new goal; and
requesting from the user confirmation of the other related goal.

11. The medium of claim 8, wherein the instructions for monitoring progress towards the goal comprise at least one selected from a group consisting of instructions for reporting a current score against a target frequency, reporting trends over time, reporting a comparison of the user to the same user in another context, and reporting a comparison of the user to other cohorts of people.

12. The medium of claim 8, wherein the instructions for suggesting opportunities to meet the goal comprise instructions for:
accessing a corpus of useful activities for meeting the goal; and
determining when to suggest useful activities for meeting the goal based on a user's schedule.

13. The medium of claim 8, wherein the instructions for suggesting opportunities to meet the goal comprise instructions for:
accessing a corpus of useful activities for meeting the goal; and
determining when to suggest useful activities for meeting the goal based on a user's current context.

14. The medium of claim 13, further comprising instructions for collecting feedback from the user on the suggested opportunity.

15. A system comprising:
a processor; and
a non-transitory computer-readable medium comprising instructions executable by the processor, the instructions for:
identifying a user goal, the goal comprising a pattern of behavior that the user wants to adopt, the pattern of behavior comprising an activity to continue at a target frequency for at least a period of time, the activity comprising an activity observable by context collectors of a mobile device or inferable from information gathered by context collectors of the mobile device;
monitoring progress towards the goal by assessing the user's behavior against the target frequency; and
suggesting opportunities to meet the goal by prompting the user to adopt behavior that advances the goal.

16. The system of claim 15, wherein the instructions for identifying the user goal comprise instructions for:
determining a change in the user's routine related to health, wellness, or enhanced enjoyment of life;
mapping the change in the user's routine to a new goal related to health, wellness, or enhanced enjoyment of life; and
requesting from the user confirmation of the new goal.

17. The system of claim 16, wherein the instructions for identifying the user goal further comprise instructions for:
suggesting to the user another related goal to the new goal; and
requesting from the user confirmation of the other related goal.

18. The system of claim 15, wherein the instructions for monitoring progress towards the goal comprise at least one selected from a group consisting of instructions for reporting a current score against a target frequency, reporting trends over time, reporting a comparison of the user to the same user in another context, and reporting a comparison of the user to other cohorts of people.

19. The system of claim 15, wherein the instructions for suggesting opportunities to meet the goal comprise instructions for:
accessing a corpus of useful activities for meeting the goal; and
determining when to suggest useful activities for meeting the goal based on a user's schedule.

20. The system of claim 15, wherein the instructions for suggesting opportunities to meet the goal comprise instructions for:
accessing a corpus of useful activities for meeting the goal; and
determining when to suggest useful activities for meeting the goal based on a user's current context.
